(19) United States
(12) Patent Application Publication
(10) Pub. No.: US 2009/0130357 A1
(43) Pub. Date: May 21, 2009

(54) Hollow body with double barrier layer

(75) Inventor: Andreas Seyler, Grundau (DE)

Correspondence Address: BUCHANAN, INGERSOLL & ROONEY PC, POST OFFICE BOX 1404, ALEXANDRIA, VA, 22313-1404, US

(73) Assignee: Veritas AG, Gelnhausen (DE)

(21) Appl. No.: 11/990,648

(22) PCT Filed: Jul. 14, 2006
(86) PCT No.: PCT/EP2006/006911

§ 371 Date: Apr. 7, 2008

(30) Foreign Application Priority Data
Aug. 19, 2005 (EP) 05018110.6

(51) Int. Cl. B32B 1/08; B29C 47/06

(52) U.S. Cl. 428/36.91; 264/209.1

(57) ABSTRACT

The present invention relates to a hollow body, in particular a tube or pipe, comprising an inner layer and an outer layer, each made from a thermoplastic material, and two barrier layers provided between the inner layer and the outer layer.

The present invention relates to a hollow body, in particular a tube or a pipe or hose, according to the preamble of claim 1.

Such a hollow body is known, for example, from the US 2004/069361 A1. A similar hollow body is known from the WO 99/57473 A.

### BACKGROUND OF THE INVENTION

Various types of hollow bodies or tubes and pipes, respectively, are known to be used in connection with the conveyance of the above mentioned media. Usually, such tubes or pipes, respectively, comprise different functional layers which are to develop, for example, a barrier effect (barrier layer), or else protect the sensitive barrier layer from external influences (protection layer). Apart from this, a number of further layers can be provided, for example colored marking layers, supporting layers for improving the mechanical properties, etc.

The known tube or pipe systems, however, are not satisfactory in every respect, in particular as a sufficient barrier effect against all above mentioned media can not be ensured in each case, so that often a new tube or pipe system has to be employed for the respective application.

In particular tube or hose pipes for fuels have to be designed such that they are chemically resistant with respect to various components of the fuel and an escape of fuel components from the pipe is additionally prevented. It is just with motor vehicles that relatively long times of parking occur, and a loss of fuel by diffusion through hose pipes is a great disadvantage from an economical as well as from an environmental point of view.

Fuels in general comprise various additives. Among these are alcoholic components, such as methyl alcohol, ethyl alcohol, or mixtures thereof with water. For example, premium gasoline comprises an alcohol content of 5% or more. Therefore, a gasoline hose or pipe for motor vehicles must not only be resistant to pure hydrocarbons, but also to added volatile hydrocarbon components containing oxygen or sulfur atoms, such as the above mentioned alcohols.

The use of simple polyamide tubes and pipes suggested in prior art is disadvantageous in that, if they contact alcohol, increases of mass of up to 10% can occur. In addition, by the alcohol, a proportion of monomers, oligomers and additives contained in the polyamide material, for example softeners, stabilizers, etc., are dissolved out. These components are conveyed into the motor together with the gasoline and can, for example, disadvantageously result in occlusions in filters and nozzles.

Therefore, in prior art, furthermore tubes or pipes, respectively, of a multilayer composite have been suggested, which contain, for example, a functional layer representing a barrier layer with respect to the medium to be conveyed. These multilayer systems usually also contain an outer layer which is to protect the barrier layer from external influences. Additionally, further layers can be provided, such as colored marking layers and supporting layers for improving the mechanical properties, etc.

The EP-A-0836042 relates to a multilayer plastic tube wherein the sheet layers and a barrier layer are positively connected to each other. The plastic tube consists of at least three layers, these layers consisting of at least two different polymers, wherein one polymeric barrier layer is embedded into a polymeric sheet layer.

As generally suited materials for barrier layers, for example fluoropolymers, such as polyvinylidene fluoride (PVDF) or ethylene tetrafluoroethylene (ETFE), have been suggested as they are resistant to polar and nonpolar solvents. Other suited materials are ethylene/vinyl alcohol copolymers (EVOH). However, the use of EVOH as the barrier layer revealed the disadvantage that this material is sensitive towards moisture and thus has to be particularly protected from moisture. Moreover, this material can only be used with small layer thicknesses as it is a particularly brittle polymer with a low elongation at tear. Too thin barrier layers, however, can not ensure the required barrier effect in the long run.

It moreover showed that with such a multilayer composite, the adhesion of the layers to each other poses a problem. The swelling of individual layers can finally result in a delamination of individual layers which is a great disadvantage.

It has therefore been furthermore suggested to use multilayer plastic tubes with two barrier layers. Thus, the EP-A-1559537, for example, describes a multilayer plastic tube with at least one support layer of at least one synthetic material and two barrier layers which each consist of a synthetic barrier layer material, such as PVDF or EVOH. To improve the adhesion of the layers to each other and avoid delamination, primer layers are interposed. These primers function as separation layer between the individual layers, in particular the two barrier layers.

The DE-A-4337491 discloses a hollow body made from a thermoplastic material with a laminate wall, comprising at least two barrier layers as well as outer layers made from a polyolefin. Between the barrier layers and the barrier layer and the outer layer, primer layers are provided to improve the adhesion of the layers.

It showed, however, that despite the use of primer layers, swelling can still occur if after some time components of fuel reach these layers. If such a primer layer swells, the adhesion of the barrier layers drastically deteriorates which can even lead to delamination. In addition, in the manufacture of such a multilayer composite by additional layers, further materials are required and additional operations are necessary, which increases the price of the tubes or pipes.

### OBJECT OF THE INVENTION

The tube or pipe systems, respectively, known in prior art are not satisfactory in every respect, as a swelling of individual layers of the laminate and as a consequence delamination can occur. It therefore was the object of the present invention to provide an improved hollow body, in particular a tube or pipe, overcoming the above mentioned problems, in particular an improved barrier effect with an improved adhesion of the individual layers.

### SUMMARY OF THE PRESENT INVENTION

The above mentioned object is achieved according to the invention by a hollow body according to claim 1. Preferred embodiments are stated in the subclaims and the following description.

The invention relates to a hollow body, in particular a tube or pipe, comprising an inner layer and an outer layer, each made from a thermoplastic material, and two barrier layers provided between the inner layer and the outer layer, characterized in that the two barrier layers are directly connected to each other.

By the direct contact of the barrier layers to each other, an additional primer layer between the two layers is eliminated. Thereby, a swelling of the intermediate layer and as a consequence delamination are excluded and the adhesion of the layers over a long period is improved, even if fuel components act thereon.

Additionally, at least one of the barrier layers comprises functional groups. Such functional groups comprise, for example, carboxylic acids or carboxylic acid anhydride derivatives thereof.

The material for such barrier layers, as it is employed according to the invention, can be manufactured by grafting on or copolymerizing the starting polymers with suited reactive compounds, for example maleic anhydride, (meth)acrylic acid or glycidyl(meth)acrylate. Mixtures thereof can also be employed. Such manufacturing processes are basically known to the person skilled in the art.

It has now been surprisingly found that by such surface-modified materials, a clearly improved adhesion of the two barrier layers to each other can be achieved without a primer layer having to be used.

The use of the above mentioned functional groups for the primer improvement has only been known for the adhesion with respect to polyamide layers up to now.

The materials for the two barrier layers preferably chemically differ from each other. Barrier layer materials suited according to the invention are in particular EVOH, PTFE, PFA, CTFE, FEP, FVDF, THV, CTFE, ECTFE, and FPM.

It is preferred according to the invention for at least one of the two barrier layers comprising a fluoric material, preferably THV or PVDF, particularly preferred PVDF.

The second barrier layer preferably comprises a material that chemically differs from the material of the first barrier layer, which can also be a fluoric material. In another preferred embodiment, the material for the second barrier layer is EVOH. An according to the invention particularly preferred combination for the two barrier layers is a barrier layer of EVOH and a barrier layer of PVDF.

The sequence of the two barrier layers from inside to outside preferably is an internally situated EVOH barrier layer, combined with a successive fluoric barrier layer, such as PVDF, which is situated somewhat more externally.

The barrier layers according to the invention preferably have thicknesses of 0.003 to 0.2 mm, resulting in a preferred total thickness of 0.004 to 0.4 mm for the double barrier layer. Preferably, the thickness of each individual barrier layer is 0.004 to 0.1 mm, resulting in a total thickness of the double barrier layer of 0.008 to 0.2 mm.

Known thermoplastic materials can be used for the inner and the outer layers. Examples of suited thermoplastic materials comprise polyamides, polyolefins or polyesters. Preferred are polyamides, particularly preferred are PA6, PA66, PA10, PA11, PA12, PA610, and PA612.

It is furthermore preferred according to the invention for the material of the inner layer to be chemically different from the material of the outer layer. Particularly preferred polyamide materials for the inner layer and the outer layer are PA6, PA66, PA610, PA12, and PA612. More particularly preferred is PA6 for the inner layer and PA12 and PA612 for the outer layer.

The inner layer and the outer layer preferably comprise a layer thickness of approximately 0.3 to 4 mm, preferably 0.3 to 2.5 mm, particularly preferred 0.3 to 2.2 mm.

By the inventive combination of the two barrier layers to form a double barrier layer, it is possible to optimize the barrier effect with respect to a plurality of media, where simultaneously less material has to be employed and where primer layers between the barrier layers can be dispensed with. In particular EVOH is a particularly good barrier layer against pure hydrocarbons, while the fluoric material has a good barrier effect against oxygenic compounds, such as alcohols. Thus, the hollow bodies according to the invention, in particular tubes or pipes, are suited for conveying hydrocarbons and fuels. By the double barrier layer effect, the service life of the pipes is clearly extended and environmental pollution reduced. At the same time, due to less required material and expenditure of labor in the manufacture, the method becomes economically more efficient.

Another advantage according to the invention is that in addition to the adhesion of the two barrier layers directly to each other, the surface modification of the materials can be correspondingly utilized for also improving the adhesion of the barrier layers to the thermoplastic materials of the inner layer and the outer layer. Therefore, further primer layers between them, as suggested in prior art, can also be avoided.

The hollow body according to the invention, in particular a tube or pipe, can be manufactured in a known manner, for example by an extrusion method. The dimensioning of the hollow body is selected depending on the desired purpose of use and can be correspondingly varied. Suited internal diameters of the enclosed hollow space are already known to the person skilled in the art.

In addition to the advantages with respect to the medium to be conveyed, saving of material moreover permits a cheaper manufacturing process as fewer operations are required and the machines used for the manufacture can be simplified. Moreover, the environmental pollution due to the disposal of the used pipes is reduced.

### BRIEF DESCRIPTION OF THE DRAWINGS

FIG. 1 shows a hollow body according to the invention with an inner layer and an outer layer and two barrier layers disposed between the inner layer and the outer layer, which are directly connected to each other.

### DETAILED DESCRIPTION OF THE PRESENT INVENTION

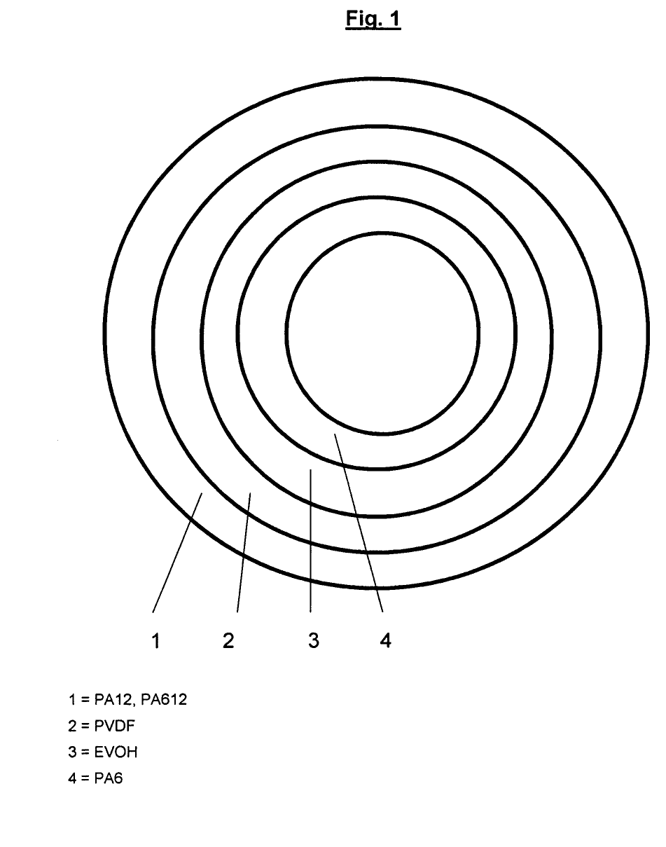

A hollow body according to the invention in the form of a multilayer pipe will be described below with respect to FIG. 1. The hollow body according to the invention comprises an outer layer 1, a first barrier layer 2, a second barrier layer 3, and an inner layer 4. The pipe according to the invention is characterized in that it comprises one layer 4, 1, each inside and outside, which are made from a thermoplastic material. The usual thermoplastic materials can be used, such as polyolefins, polyamides or polyesters. Preferred according to the invention are polyamides, such as PA6, PA66, PA10, PA11, PA12, PA610, and PA612, etc. According to the invention it is preferred for the material of the inner layer 4 to be chemically different from the material of the outer layer 1. Polyamide materials preferred according to the invention for the inner layer 4 and the outer layer 1 are PA6, PA66, PA610, PA12, and PA612. Particularly preferred are PA6, PA12 and PA612, PA6 being particularly preferably used for the inner layer 4, while PA12 and PA612, respectively, are preferably used for the outer layer 1.

The inner layer 4 and the outer layer 1 preferably comprise a layer thickness of approximately 0.3 to 4 mm, preferably 0.3 to 2.5 mm, particularly preferred 0.3 to 2.2 mm, such as, for example, 0.3 to 1.7 mm or 0.4 to 1.2 mm.

The double barrier layer 2, 3 according to the invention comprises two layers 2, 3 made from a typical barrier layer material, wherein the two layers 2, 3 chemically differ from one another. Barrier layer materials suited according to the invention are in particular EVOH, PTFE, PFA, ETFE, FEP, PVDF, THV, CTFE, ECTFE, and FPM. It is preferred according to the invention for at least one of the two barrier layers 2 to comprise a fluoric material, preferably THV or PVDF, particularly preferred PVDF. The further barrier layer 3 comprises a fluoric material that chemically differs from the first barrier layer 2, such as the ones mentioned above, or EVOH. It is preferred for one of the two barrier layers 3 to comprise EVOH. A particularly preferred combination for the double barrier layer 2, 3 is thus a barrier layer 3 of EVOH, combined with a barrier layer 2 of PVDF or THV, in particular PVDF. That means, the particularly preferred combination comprises a barrier layer 3 of EVOH, combined with a barrier layer 2 of PVDF. The sequence of these two barrier layers (from inside to outside) can in principle be arbitrarily selected, however, an EVOH barrier layer 3 situated further inside, combined with a (further outside) successive fluoric barrier layer 2, in particular PVDF, is preferred.

The barrier layers 2, 3 according to the invention preferably have thicknesses of 0.002 to 0.2 mm, resulting in a preferred total thickness of 0.004 to 0.4 mm for the double barrier layer. Preferably, the thickness of each individual barrier layer 2, 3 is approximately 0.004 to 0.1 mm, resulting in a total thickness of the double barrier layer 2, 3 of 0.008 to 0.2 mm.

By the inventive combination of the two barrier layers 2, 3 to form a double barrier layer it is possible to maximize the barrier effect with respect to a plurality of media, simultaneously less material having to be employed. In particular in the preferred combinations for the barrier layer 2, 3, i.e. an EVOH barrier layer 3 combined with a fluoric barrier layer 2, in particular PVDF, an excellent combined barrier effect can be obtained. While EVOH develops a particularly good barrier effect against pure hydrocarbons, the fluoric material, in particular PVDF, shows a very good barrier effect against oxygenic compounds, i.e. hydrocarbon derivatives characterized by oxygen containing functional groups (such as alcohols). Thus, the tubes or pipes according to the invention are suited for conveying a mixture of pure hydrocarbons, e.g. diesel and derivatives thereof, as well as for successively conveying various materials, e.g. gasoline (as stated above, e.g. first pure hydrocarbons, subsequently oxygenic compounds). According to the invention, an excellent barrier effect is ensured without conveyance lines having to be exchanged, for example.

The pipe according to the invention or the tube according to the invention, respectively, preferably only comprises the four essential layers discussed above (inner layer 4, outer layer 1, two barrier layers 2, 3). However, it is also possible for the pipe according to the invention or the tube according to the invention, respectively, to comprise further layers, for example adhesion promoting layers between one of the barrier layers 2, 3 and the adjacent inner or outer layer 4, 1, as well as supporting layers (reinforcing materials, such as glass fibers, etc.), or else colored marking layers. Materials suited for such further layers are known to the person skilled in the art.

An advantage according to the invention is that between the constituting layers 1, 2, 3, 4 of the hollow body according to the invention, no adhesive layers are required to obtain sufficient adhesion. According to the invention, direct bonding can be employed, wherein possibly a slight additivation and/or direct chemical modification of the barrier layer material is advantageous. It is thus for example advantageous according to the invention for the fluoric barrier layer materials to be equipped with suited functional groups in the above-described manner, for example by grafting on, to thus ensure sufficient adhesion to a respective adjacent barrier layer 2, 3 and/or to polyamide. Suited functional groups are, for example, acid anhydride groups or derivatives thereof, in particular maleic anhydride groups. Thus, PVDF grafted with maleic anhydride, for example, has a better adhesion to polyamides, compared to pure PVDF. This exemplary design analogously applies for the further fluoric barrier layer materials listed in the present application. In contrast, EVOH directly, i.e. without additive, adheres to polyamide as well as to the fluoric materials to be used according to the invention, such as in particular PVDF and modified PVDF.

According to the invention, the preferred embodiment as represented in FIG. 1 is obtained. In FIG. 1, the above described pipe is shown in a cross-section with the four constituting layers 1, 2, 3, 4, which are selected as follows: for the outer layer 1, material PA12 or PA612 is provided. This is followed by the first barrier layer 2 made from PVDF, preferably PFDV grafted with maleic anhydride (for improving adhesion to the polyamide). Subsequently, the second barrier layer 3 made from EVOH follows, wherein neither an additive nor a chemical modification of the barrier layer material is necessary for ensuring adhesion. Finally, the inner layer 4 made from polyamide, preferably from PA6, is provided.

The pipe according to the invention or the tube according to the invention can be manufactured in a common way, for example in an extrusion method. The dimensioning of the pipe or the tube, respectively, is selected depending on the desired purpose of use. Suited internal diameters of the enclosed hollow space are known to the person skilled in the art.

1-11. (canceled)

12. Hollow body, in particular a tube or pipe, comprising an inner layer and an outer layer, each made from a thermoplastic material, and two barrier layers provided between the inner layer and the outer layer, wherein, the two barrier layers are directly connected to each other, wherein the material of at least one of the two barrier layers comprises functional groups to ensure adhesion to the adjacent barrier layer.

13. Hollow body according to claim 12, wherein the materials of the two barrier layers chemically differ from each other.

14. Hollow body according to one of claims 12, wherein the material for the barrier layers is selected from THV, PVDF, PTFE, PFA, FEP, CTFE, ECTFE, FPM, and EVOH.

15. Hollow body according to claim 14, wherein one of the barrier layers comprises PVDF and the other barrier layer comprises EVOH.

16. Hollow body according to 12, wherein the thermoplastic material for the inner layer and the outer layer is selected from the group of the polyamides.

17. Hollow body according to claim 16, wherein the polyamide material is selected from the group consisting of polyamide 6, polyamide 66, polyamide 12 and polyamide 612.

18. Hollow body according to claim 12, wherein the material of at least one of the two barrier layers comprises functional groups, selected from the group consisting of carboxylic acid and carboxylic acid anhydride derivatives.

19. Hollow body according to claim 18, wherein the functional groups are selected from the group consisting of maleic anhydride, (meth)acrylic acid or glycidyl(meth)acrylate.

20. Method for the manufacture of a hollow body according to claim 12, comprising the step of coextruding several layers, wherein the two barrier layers are directly connected to each other.

21. Use of the hollow body according to claim 12 as gasoline pipe.

22. Hollow body according to claim 13, wherein the material for the barrier layers is selected from THV, PVDF, PTFE, PFA, FEP, CTFE, ECTFE, FPM, and EVOH.

23. Hollow body according to 15, wherein the thermoplastic material for the inner layer and the outer layer is selected from the group of the polyamides.

24. Hollow body according to claim 18, wherein the material of at least one of the two barrier layers comprises functional groups, selected from the group consisting of carboxylic acid and carboxylic acid anhydride derivatives.

25. Method for the manufacture of a hollow body according to claim 19, comprising the step of coextruding several layers, wherein the two barrier layers are directly connected to each other.

26. Use of the hollow body according to claim 19 as gasoline pipe.
